(19) United States
(12) Patent Application Publication
(10) Pub. No.: US 2017/0207903 A1
(43) Pub. Date: Jul. 20, 2017

(54) METHOD AND APPARATUS FOR PERFORMING DE-SKEW CONTROL

(71) Applicant: Faraday Technology Corp., Hsin-Chu City (TW)

(72) Inventor: Chih-Cheng Chiu, Hsin-Chu City (TW)

(21) Appl. No.: 15/173,702

(22) Filed: Jun. 5, 2016

(30) Foreign Application Priority Data
Jan. 19, 2016 (TW) 105101491

(51) Int. Cl. H04L 7/00; H04B 3/04

(52) U.S. Cl. CPC H04L 7/0016; H04L 7/005; H04B 3/04

(57) ABSTRACT

A method and apparatus for performing de-skew control are provided, where the method is applied to an electronic device. The method includes: buffering a plurality of data sequences for performing symbol detection on a plurality of channels; according to a first symbol on a first channel, determining corresponding first expected symbols on other channels to determine a plurality of candidate expected symbol positions on the other channels, respectively; according to at least one other symbol on the first channel, within the candidate expected symbol positions on the other channels, eliminating any candidate expected symbol position that does not comply with a predetermined format to obtain a plurality of expected symbol positions on the other channels; and utilizing the expected symbol positions as correct positions of the corresponding first expected symbols on the other channels to control respective data of the data sequences to be synchronously transmitted.

### BACKGROUND OF THE INVENTION

1. Field of the Invention

The present invention relates to solving data skew which occurs in an electronic device when receiving network signals on twisted pairs, and more particularly, to a method and an associated apparatus for performing de-skew control.

2. Description of the Prior Art

Data skew problem may occur when using an electronic device having a network interface circuit to perform data transmission. The network interface circuit may include a connector for connecting a network cable in order to access network resources through the network cable, wherein the network cable usually has multiple twisted pairs (e.g. four twisted pairs) for transmitting network signals. The electronic device needs an additional control scheme to solve the data skew problem, but some side effects will be introduced. One related art method suggests using three search windows of three twisted pairs to find corresponding data. If only several bits of the data sequences on a specific twisted pair meet the requirement, however, these bits are not ensured to be correct data. The probability of using the three search windows to find correct data amongst the three data sequences on the three twisted pairs corresponds to both the size of the three search windows and the data comparing times. This makes the size of the entire hardware scheme (in particular, the size of the buffer) too large, thus increasing the cost. Further, the more data comparing times results in an increase in calculation loadings, meaning the electronic device is not applicable for high speed network transmissions, such as 1 or 10 Gigabit Ethernet (GbE) network transmissions. Hence, there is a need for a novel method to improve the data transmission efficiency.

### SUMMARY OF THE INVENTION

An objective of the present invention is to provide a method and an apparatus to perform de-skew control, to solve the above-mentioned problems.

Another object of the present invention is to provide a method and an apparatus to perform de-skew control, to improve the data transmission efficiency.

Yet another object of the present invention is to provide a method and an apparatus to perform de-skew control, to improve the performance of an electronic device with reduced side effects.

According to an embodiment of the present invention, a method for performing de-skew control is provided. The method is applied to an electronic device. The method comprises: buffering a plurality of data sequences from a plurality of twisted pairs of a network cable to perform symbol detection upon a plurality of channels corresponding to the twisted pairs, respectively; based on a predetermined format, referring to a first symbol on a first channel within the plurality of channels to determine corresponding first expected symbols on other channels of the plurality of channels, in order to determine a plurality of candidate expected symbol positions on the other channels, respectively, wherein the number of the candidate expected symbol positions is larger than the number of the other channels; based on the predetermined format, referring to at least one other symbol on the first channel to exclude any of the candidate expected symbol positions that does not conform to the predetermined format, in order to obtain a plurality of expected symbol positions on the other channels, respectively, wherein the number of the expected symbol positions is equal to the number of the other channels, and the expected symbol positions correspond to the other channels, respectively; and utilizing the expected symbol positions as correct positions of the corresponding first expected symbols on the other channels, respectively, and referring to the correct positions to selectively delay at least one data sequence of the data sequences, in order to control respective data of the data sequences to be synchronously transmitted, to thereby perform de-skew.

According to another embodiment of the present invention, an apparatus for performing de-skew control is provided. The apparatus comprises a buffer, a format information generator, an expected symbol position generator and a de-skew circuit. The buffer is located in an electronic device, and the buffer is arranged to buffer a plurality of data sequences from a plurality of twisted pairs in a network cable in order to perform symbol detection upon a plurality of channels corresponding to the plurality of twisted pairs. The format information generator is located in the electronic device, and the format information generator is arranged to generate format information of a predetermined format. The expected symbol position generator is located in the electronic device, and the expected symbol position generator is coupled to the buffer and the format information generator. Based on the predetermined format, the expected symbol position generator refers to a first symbol on a first channel within the plurality of channels to determine corresponding first expected symbols on other channels of the plurality of channels, in order to obtain a plurality of candidate expected symbol positions on the other channels, respectively, wherein the number of the candidate expected symbol positions is larger than the number of the other channels. Based on the predetermined format, the expected symbol position generator refers to at least one other symbol on the first channel to exclude any of the candidate expected symbol positions that does not conform to the predetermined format, to obtain a plurality of expected symbol positions on the other channels, respectively, wherein the number of the plurality of expected symbol positions equals the number of the other channels, and the plurality of expected symbol positions correspond to the other channels, respectively. The de-skew circuit is located in the electronic device, and the de-skew circuit is coupled to the buffer and the expected symbol position generator. The de-skew circuit is arranged to utilize the plurality of expected symbol positions as correct positions of the corresponding first expected symbols on the other channels, respectively, and refer to the correct positions to selectively delay at least one data sequence of the plurality of data sequences, in order to control respective data of the data sequences to be synchronously transmitted, to thereby perform de-skew.

An advantage of the method and apparatus of the present invention is that the data transmission efficiency can be improved. Further, compared with the related art, the method and apparatus of the present invention can improve the performance of an electronic device with reduced side effects. More particularly, the present invention may avoid the problem of the hardware structure being too large or too complex. In addition, the latency time is also reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an apparatus for performing de-skew control according to an embodiment of the present invention.

FIG. 2 is a flowchart illustrating a method for performing de-skew control according to an embodiment of the present invention.

FIG. 3 is a workflow of the method shown in FIG. 2 according to an embodiment of the present invention.

FIG. 4 is a diagram illustrating a related art method.

FIG. 5 is a diagram illustrating a control scheme of the method shown in FIG. 2 according to an embodiment of the present invention.

FIG. 6 is a diagram illustrating implementation details of the control scheme shown in FIG. 5 according to an embodiment of the present invention.

### DETAILED DESCRIPTION

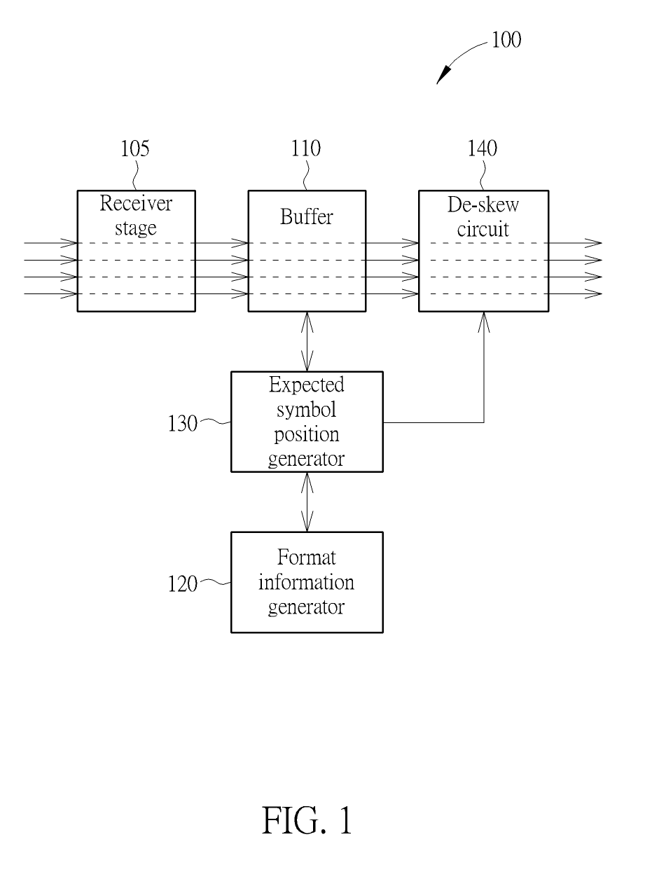

FIG. 1 is a diagram illustrating an apparatus 100 for performing de-skew control according to an embodiment of the present invention. The apparatus 100 includes at least one portion (e.g. part or all) of an electronic device. For example, the apparatus 100 may include a control circuit of the electronic device, such as a control circuit implemented with an integrated circuit (IC). In another example, the apparatus 100 may include the entire electronic device. In yet another example, the apparatus 100 may be a system including the electronic device, e.g. a computer system. Examples of the electronic device may include, but are not limited to, a personal computer, external storage equipment (e.g. an external hard drive), or an inner module of a personal computer. According to this embodiment, the electronic device may include a network interface circuit. The network interface circuit of the electronic device may include a connector for connecting to a network cable for accessing network resources via the network cable, wherein the network cable may include a plurality of twisted pairs (e.g. four twisted pairs) for transmitting network signals.

Since Ethernet over twisted Pairs techniques may be well-known, some implementation details are omitted here for brevity. Under increased transmission speed, the signal quality becomes an important issue. One related art method ensures the signal quality by upgrading all network cables of the network system to new generation ones, such as upgrading the CAT-5 cables to the CAT-6 cables. This approach inevitably increases the cost. The present invention is capable of ensuring the signal quality under the improved transmission speed without upgrading the current version cables (e.g. the CAT-5 cables), so that the existing cables to be used for high speed network transmissions, such as 1 Gigabit Ethernet (GbE) or 10 Gigabit Ethernet. Based on the scheme shown in FIG. 1, the present invention may provide the electronic device with better data transmission efficiency without introducing side effects. In some embodiments, the electronic device may include a plurality of processing paths corresponding to the plurality of twisted pairs, respectively, such as four processing paths corresponding to four twisted pairs. This is merely for illustrative purposes, and not meant to be a limitation of the present invention.

As shown in FIG. 1, the apparatus 100 comprises a receiver stage 105, a buffer 110, a format information generator 120, an expected symbol position generator 130, a de-skew circuit 140, wherein the expected symbol position generator 130 is coupled to the buffer 110 and the format information generator 120, and the de-skew circuit 140 is coupled to the buffer 110 and the expected symbol position generator 130. The receiver stage 105, the buffer 110, the format information generator 120, the expected symbol position generator 130, and the de-skew circuit 140 are located in the electronic device. For example, the buffer 110 may comprise a first-in-first-out (FIFO) buffer. This is merely for illustrative purposes.

In this embodiment, the receiver stage 105 receives differential signals from the twisted pairs (through the connector) to obtain a plurality of data sequences, respectively, wherein the plurality of data sequences correspond to the plurality of differential signals, respectively. Further, the plurality of data sequences may be inputted to the plurality of processing paths, and the plurality of processing paths go through the buffer 110 and the de-skew circuit 140, and reach the next stage of the de-skew circuit 140. Under the situation where the number of twisted pairs is four, the number of the data sequences and processing paths will also be four. In some embodiments, the next stage of the de-skew circuit 140 may comprise a Viterbi Decoder.

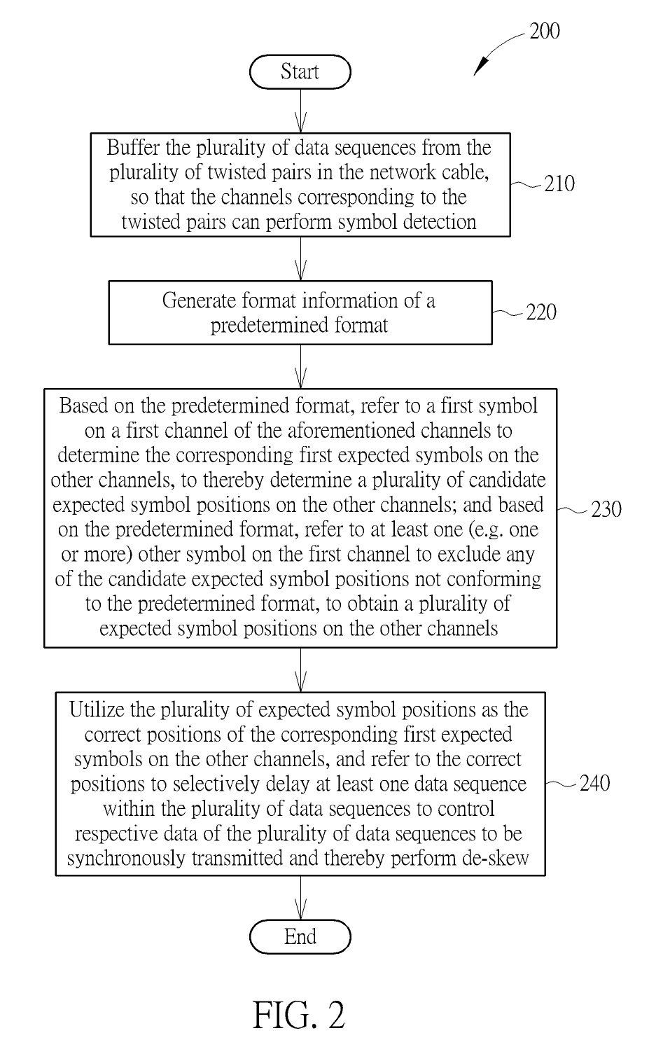

Based on the structure shown in FIG. 1, the apparatus 100 (especially the expected symbol position generator 130 therein) may perform de-skew control to ensure the correctness of data, in order to improve the data transmission efficiency of the electronic device. The detailed implementations are shown in FIG. 2.

FIG. 2 is a flowchart illustrating a method 200 for performing de-skew control according to an embodiment of the present invention. The method 200 may be applied to the apparatus 100 shown in FIG. 1, and is described as follows.

In Step 210, the buffer 110 (e.g. the first-in-first-out (FIFO) buffer or any other type of buffer) may buffer the plurality of data sequences from the plurality of twisted pairs in the network cable, so that the channels corresponding to the twisted pairs (e.g. the aforementioned processing paths) can perform symbol detection. Under the situation where the number of twisted pairs is four, there are four channels A, B, C and D, which are denoted as Aₙ, Bₙ, Cₙ and Dₙ, respectively.

In Step 220, the format information generator 120 may generate format information of a predetermined format. According to this embodiment, the plurality of data sequences may carry predetermined data conforming to the predetermined format. For example, the predetermined data may comprise idle data, and the predetermined format may comprise an idle data format, wherein the idle data format indicates the predetermined arrangement of the symbols of the idle data. In some embodiments, the predetermined data may be other types of data, and the predetermined format may be other types of format. The details of the idle data format may be well-known, and are omitted here for brevity.

In Step 230, based on the predetermined format, the expected symbol position generator 130 may refer to a first symbol on a first channel of the aforementioned channels (e.g. the channel A) to determine the corresponding first expected symbols on the other channels of the aforementioned channels (e.g. the channels B, C and D), to thereby determine a plurality of candidate expected symbol positions on the other channels, wherein the number of the candidate expected symbol positions is larger than the number of the other channels. Further, based on the predetermined format, the expected symbol position generator 130 may refer to at least one (e.g. one or more) other symbol on the first channel (e.g. the channel A) to exclude any of the candidate expected symbol positions that does not conform to the predetermined format, to obtain a plurality of expected symbol positions on the other channels (e.g. the channels B, C and D), wherein the number of the plurality of expected symbol positions is equal to the number of the other channels, and the number of the expected symbol positions corresponds to the number of the other channels. For example, the expected symbol position generator 130 may sequentially exclude any of the candidate expected symbol positions that does not conform to the predetermined format, and reserve the remaining candidate expected symbol positions conforming to the predetermined format. After Step 230 is performed, the expected symbol position generator 130 may determine that the expected symbol positions are the remaining candidate expected symbol positions conforming to the predetermined format, respectively.

In Step 240, the de-skew circuit 140 may utilize the plurality of expected symbol positions as the correct positions of the corresponding first expected symbols on the other channels (e.g. the channels B, C and D), and refer to the correct positions to selectively delay at least one data sequence within the plurality of data sequences (e.g. the data sequences on one or more of the channels A, B, C and D) in order to control respective data of the data sequences to be synchronously transmitted, to thereby perform de-skew. For example, the operation of selectively delaying the data sequence may be implemented with a delay circuit (which may comprise at least one series of delay units). According to some embodiments, the operation of selectively delaying the data sequence may be implemented by directly selecting the correct data corresponding to an offset amount in the data sequence, wherein the offset amount may correspond to the difference between a specific expected symbol position (e.g. one of the corresponding first expected symbols) and the position of the first symbol, and this difference may be a positive value, 0, or a negative value. For example, under the situation where the plurality of channels comprise the four channels A, B, C, and D, the de-skew circuit 140 may refer to a set of offset amounts OFFSET_{B}, OFFSET_{C}, and OFFSET_{D} to directly select the correct data on the four channels A, B, C, and D, and output the selected correct data to the next stage, wherein the offset amount of channel A OFFSET_{A} may be viewed as zero, and the offset amounts OFFSET_{B}, OFFSET_{C}, and OFFSET_{D} may correspond to the plurality of expected symbol positions, respectively. More particularly, the offset amounts OFFSET_{B}, OFFSET_{C} and OFFSET_{D} may be an example of the plurality of expected symbol positions, i.e. the plurality of expected symbol positions may be the offset amounts OFFSET_{B}, OFFSET_{C}, and OFFSET_{D}, respectively. In another example, under the situation where there are four channels A, B, C, and D, the de-skew circuit 140 may refer to a set of offset amount OFFSET_{A}, OFFSET_{B}, OFFSET_{C}, and OFFSET_{D} to directly select the correct data on the four channels A, B, C, and D, and output the selected correct data to the next stage.

The work flow is illustrated as Steps 210-240, although this is merely for illustrative purposes. According to some embodiments, the work flow may be modified. For example, at least one portion (e.g. part or all) of Steps 210-240 may be repeatedly executed. In another example, Step 230 and Step 240 can be executed at the same time.

According to some embodiments, in Step 230, based on the predetermined format, the expected symbol position generator 130 may refer to the other symbol on the first channel (e.g. the channel A) to determine the corresponding other expected symbols on the other channels (e.g. the channels B, C and D). Further, the expected symbol position generator 130 may discard any of the candidate expected symbol positions where the corresponding other expected symbols do not appear on the other channels (e.g. the channels B, C and D), in order to exclude any of the candidate expected symbol positions that does not conform to the predetermined format. According to some embodiments, in Step 230, the other symbol on the first channel (e.g. the channel A) may comprise a second symbol. Further, based on the predetermined format, the expected symbol position generator 130 may refer to the second symbol on the first channel (e.g. the channel A) to determine corresponding second expected symbols on the other channels (e.g. the channels B, C and D), wherein the corresponding other expected symbols may comprise the corresponding second expected symbols. Further, the symbol position generator 130 may discard any of the candidate expected symbol positions where the corresponding second expected symbols do not appear on the other channels (e.g. the channels B, C and D), in order to exclude any of the candidate expected symbol positions that does not conform to the predetermined format.

In another example, the other symbol on the first channel (e.g. the channel A) may further comprise a third symbol. Based on the predetermined format, according to the third symbol on the first channel (e.g. the channel A), the expected symbol position generator 130 may determine corresponding third expected symbols on the other channels (e.g. the channels B, C and D), wherein the corresponding other expected symbols may further comprise the corresponding third expected symbols. The expected symbol position generator 130 may discard any of the candidate expected symbol positions where the corresponding third expected symbols do not appear on the other channels (e.g. the channels B, C and D), in order to exclude any of the candidate expected symbol positions that does not conform to the predetermined format.

In another example, the other symbol on the first channel (e.g. the channel A) may further comprise a fourth symbol. Based on the predetermined format, according to the fourth symbol on the first channel (e.g. the channel A), the expected symbol position generator 130 may determine corresponding fourth expected symbols on the other channels (e.g. the channels B, C and D), wherein the corresponding other expected symbols may further comprise the corresponding fourth expected symbols. In the candidate expected symbol positions, the expected symbol position generator 130 may discard any of the candidate expected symbol positions where the corresponding fourth expected symbols do not appear on the other channels (e.g. the channels B, C and D), in order to exclude any of the candidate expected symbol positions that does not conform to the predetermined format.

Based on the method 200 shown in FIG. 2, since any candidate expected symbol positions that does not conform to the predetermined format will be excluded, the number of candidate expected symbol positions decreases quickly, so that the expected symbol positions can be selected from the candidate expected symbol positions quickly. The electronic device implemented with the method 200 and the apparatus 100 of the present invention does not need to determine any search window, and does not need to occupy too much buffer space (especially the buffer space assigned for the three search windows) for increasing the probability of finding the correct data. The electronic device implemented with the method 200 and the apparatus 100 of the present invention may avoid the problem of the entire hardware structure being too large or complex. In addition, the latency time may also be reduced.

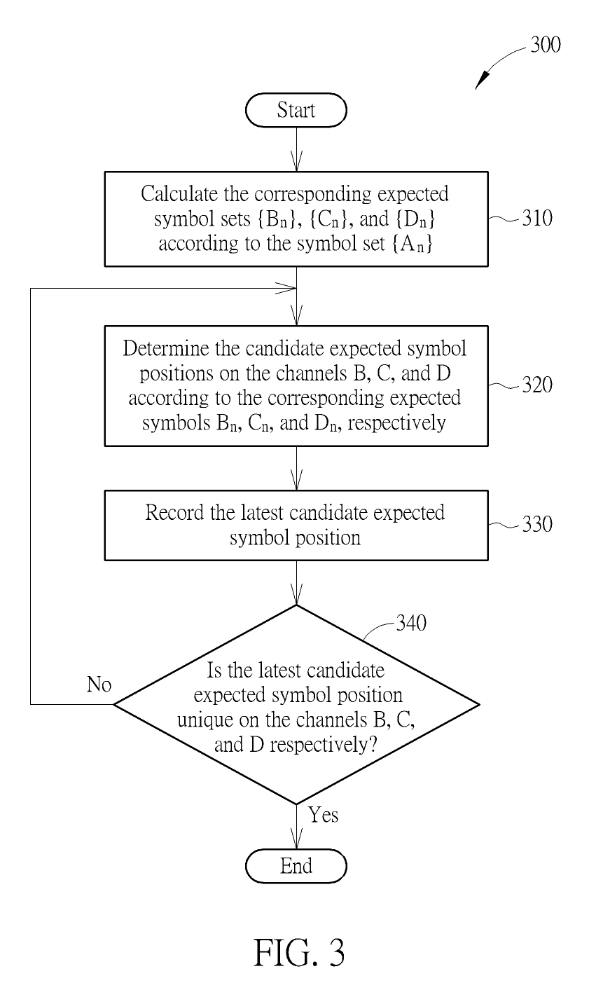

FIG. 3 is a workflow 300 of the method shown in FIG. 2 according to an embodiment of the present invention. The work flow 300 may be an example of Step 230. Note that, under the situation where the data skew is severe, the other symbol may comprise multiple other symbols. Based on the predetermined format, the expected symbol position generator 130 may refer to the other symbols to sequentially discard any of the candidate expected symbol positions where the corresponding other expected symbols do not appear on the other channels (e.g. the channels B, C and D), until there is only one unique candidate expected symbol position on each of the other channels (e.g. the channel B, C, and D), wherein the unique candidate expected symbol position is one of the plurality of expected symbol positions. This is merely for illustrative purposes; under the situation where the aforementioned data skew problem is not severe, the other symbol may be a single other symbol. Based on the predetermined format, the expected symbol position generator 130 may refer to the single other symbol to discard any of the candidate expected symbol positions where the corresponding other expected symbols do not appear on the other channels (e.g. the channels B, C and D), until there is only one unique candidate expected symbol position on each of the other channels (e.g. the channel B, C, and D), wherein the unique candidate expected symbol position is one of the plurality of expected symbol positions.

In Step 310, based on the predetermined format, the expected symbol position generator 130 may refer to the symbol set {Aₙ} to calculate the corresponding expected symbol sets {Bₙ}, {Cₙ}, and {Dₙ}, wherein the subscript “n” represents the index in a data sequence. The symbols Aₙ, Bₙ, Cₙ, and Dₙ having the same index n belong to the same set of instantaneous time coding, wherein the index n corresponds to a specific instantaneous timing. According to some embodiments, however, the symbol set {Aₙ} may comprise the symbols Aₙ, Aₙ₊₁, Aₙ₊₂, . . . , the symbol set {Bₙ} may comprise the symbols Bn, Bₙ₊₁, Bₙ₊₂, . . . , the symbol set {Cₙ} may comprise the symbols Cₙ, Cₙ₊₁, Cₙ₊₂, . . . , and the symbol set {Dₙ} may comprise the symbols Dₙ, Dₙ₊₁, Dₙ₊₂, . . . . The expected symbol position generator 130 therefore not only refers to the symbol Aₙ to calculate the expected symbols Bₙ, Cₙ, and Dₙ, but also refers to the symbol Aₙ₊₁ to calculate the expected symbols Bₙ₊₁, Cₙ₊₁, and Dₙ₊₁, refers to the symbol Aₙ₊₂ to calculate the expected symbols Bₙ₊₂, Cₙ₊₂, and Dₙ₊₂, and refers to the symbol Aₙ₊₃ to calculate the expected symbols Bₙ₊₃, Cₙ₊₃, and Dₙ₊₃, and so on. According to some embodiments, the expected symbol position generator 130 may refer to the symbol Aₙ₋₁ to calculate the expected symbols Bₙ₋₁, Cₙ₋₁, and Dₙ₋₁.

In Step 320, the expected symbol position generator 130 refers to the corresponding expected symbols Bₙ, Cₙ, and Dₙ to determine the candidate expected symbol positions on the channels B, C, and D, such as the positions of the channels B, C, and D on which the corresponding expected symbols Bₙ, Cₙ, and Dₙ appear. According to some embodiments, when Step 320 is performed a next time, the index n is adjusted by adding 1 (e.g. the index n will be sequentially replaced by n+1, n+2, n+3, and so on). The expected symbol position generator 130 may refer to the symbol Aₙ₊₁ to discard any of the candidate expected symbol positions where the expected symbols Bₙ₊₁, Cₙ₊₁, and Dₙ₊₁ do not appear on the channels B, C, and D, refer to the symbol Aₙ₊₂ to discard any of the candidate expected symbol positions where the expected symbol Bₙ₊₂, Cₙ₊₂, and Dₙ₊₂ do not appear on the channels B, C, and D, refer to the symbol Aₙ₊₃ to discard any of the candidate expected symbol positions where the expected symbols Bₙ₊₃, Cₙ₊₃, and Dₙ₊₃ do not appear on the channels B, C, and D, and so on. In this way, the expected symbol position generator 130 may exclude any of the candidate expected symbol positions that does not conform to the predetermined format. In practice, since the apparatus 100 may subsequently process the symbols of the data sequences on the channels A, B, C, and D, the symbols on the data sequences may be viewed as flowing through the channels A, B, C, and D. In this way, when Step 320 is performed once again, the expected symbol position generator 130 allows the symbols on the data sequences to shift one symbol position on the channels A, B, C, and D. This is equivalent to adding 1 on the index n. Hence, the operation of “adding 1 on the index n” does not need to be mentioned in the work flow 300.

In Step 330, the expected symbol position generator 130 may record the latest candidate expected symbol position, such as the latest determined candidate expected symbol position in Step 320.

In Step 340, the expected symbol position generator 130 may check whether the latest candidate expected symbol position recorded in Step 330 (e.g. the latest determined candidate expected symbol position in Step 320) is unique on the channels B, C, and D, respectively. If the latest candidate expected symbol position recorded in Step 330 is unique on the channels B, C, and D, respectively, the work flow 300 ends; otherwise, Step 320 is re-entered.

According to this embodiment, the latest candidate expected symbol positions are unique on the channels B, C, and may represent the offset amounts OFFSET_{B}, OFFSET_{C}, and OFFSET_{D}, and may be used as the plurality of expected symbol positions. Hence, the de-skew circuit 140 may utilize the plurality of expected symbol positions as the respective correct positions of the corresponding first expected symbols on the other channels (e.g. the channels B, C and D) to control respective data of the symbols Aₙ, Bₙ, Cₙ, and Dₙ to be synchronously outputted to the next stage. Some features in this embodiment similar to those in the previous embodiments are omitted here for brevity.

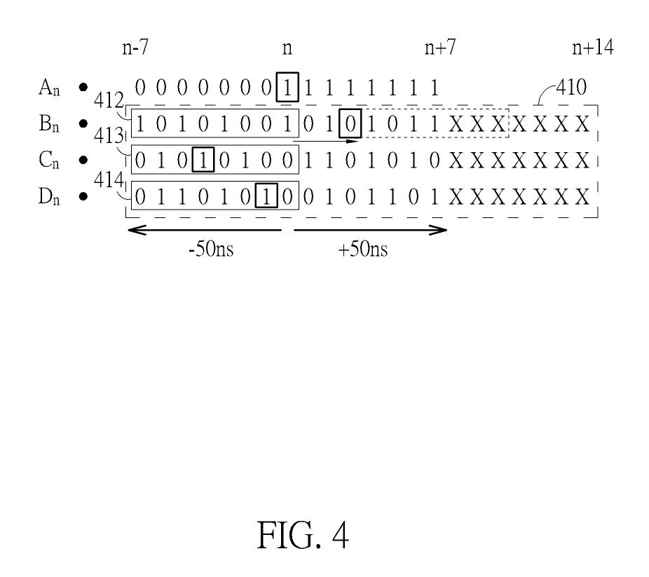

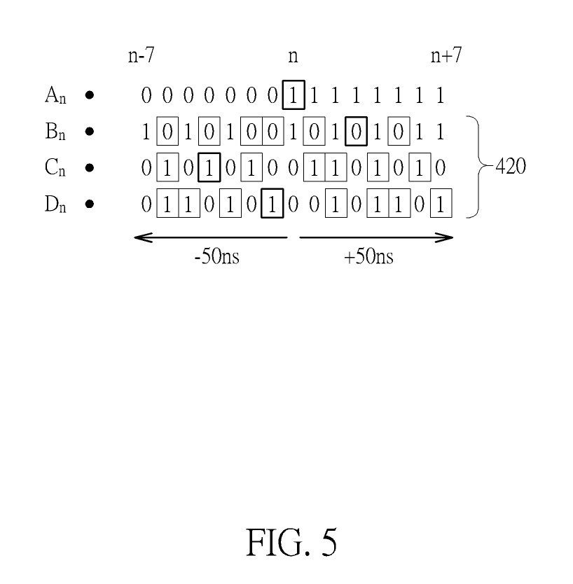

FIG. 4 is a diagram illustrating a related art method, and FIG. 5 is a diagram illustrating a control scheme involved with the method 200 shown in FIG. 2 according to an embodiment of the present invention. It is assumed that the symbols Aₙ, Bₙ, Cₙ, and Dₙ corresponding to the index n represent the logic values 1, 0, 1, and 1, respectively (as highlighted by the four bold face frames in FIGS. 4 and 5), which can also be denoted as (1011)ₙ. According to the predetermined format such as the idle data format, the correct data of the data sequences may be as follows:

. . . (0100)ₙ₋₁→(1011)ₙ→(1100)ₙ₊₁→(1010)ₙ₊₂→(1101)n+3→ . . .

The data skew problem shown in FIG. 4 is not very severe. It can, however, be very severe in practice. Under the situation where the data skew problem is very severe, the distances among the symbols Aₙ, Bₙ, Cₙ, and Dₙ in (1011)ₙ (as highlighted by the four bold face frames) will be longer. As described above, if only several bits of the data sequences on a specific twisted pair meet the requirement, these bits are not ensured to be correct data. If the sizes of the search windows 412, 413 and 414 applied in the related art method are not large enough, the probability of finding the correct data will be relatively low. As shown in FIG. 4, the lengths of each of the search windows 412, 413 and 414 are only 8 symbols, while there is a total of 22 symbols which need to be searched, i.e. 15 symbols (the (n−7)th-(n+7)th symbols) are within −50 nanosecond (ns) to +50 ns, and another 7 symbols represented by X are positioned after the (n+7)th symbol. In other words, if x=x0, wherein x0 is much larger than 8, besides the 15 symbols, there are also (x0-1) symbols X (i.e. the (n+8)-(n+x0+6)th symbols) which need to be searched. To improve the probability of obtaining the correct data, the search windows 412, 413 and 414 must be large enough. This makes the entire hardware structure (especially the size of buffers) too large, and the cost is correspondingly increased. Compared with the related art method, the control scheme provided in FIG. 5 does not need to utilize search windows such as the search windows 412, 413 and 414, thus avoiding the related art problem. Based on the control scheme, the expected symbol position generator 130 may record the latest determined candidate expected symbol position in Step 320, such as the candidate expected symbol position 420 shown in FIG. 5 (i.e. the bold face frames corresponding to the channels B, C, and D), and may exclude any of the candidate expected symbol positions that does not conform to the predetermined format through repeatedly executing the loop of the work flow 300. Some features in this embodiment similar to those in the previous embodiments are omitted here for brevity.

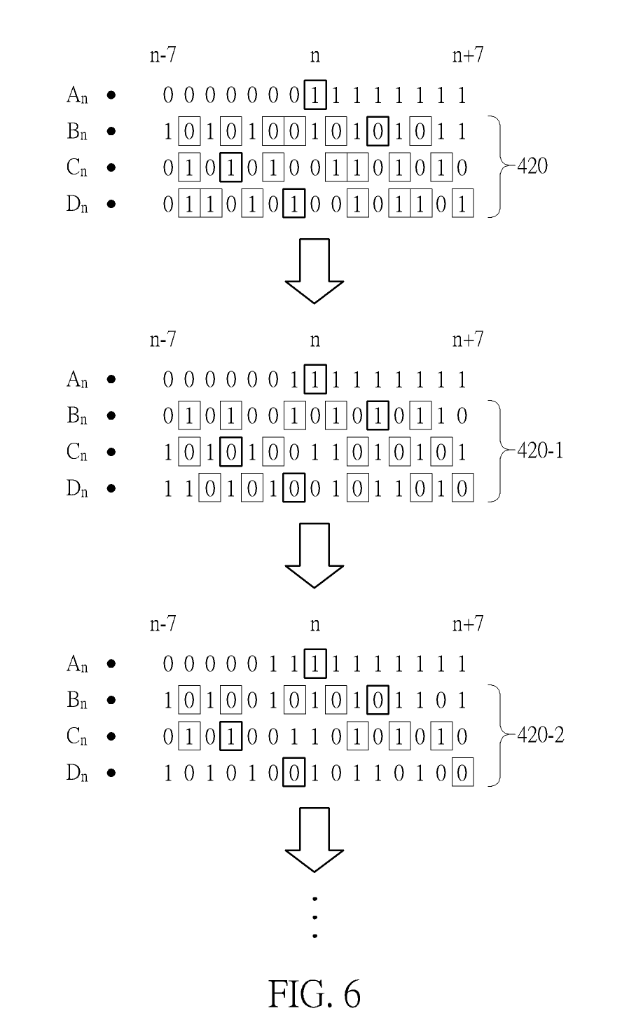

FIG. 6 is a diagram illustrating implementation details of the control scheme shown in FIG. 5 according to an embodiment of the present invention, wherein the expected symbol position generator 130 may utilize the work flow 300 to exclude any candidate expected symbol positions that does not conform to the predetermined format. For example, the candidate expected symbol position 420 may be right-shifted to be the candidate expected symbol position 420-1, the candidate expected symbol position 420-1 may be right-shifted to be the candidate expected symbol position 420-2, and so on.

As shown in the topmost part of FIG. 6, in the first processing stage corresponding to the candidate expected symbol position 420, the symbols Aₙ, Bₙ, Cₙ, and Dₙ of (1011)ₙ (as highlighted by the bold face frames) are followed by the symbols Aₙ₊₁, Bₙ₊₁, Cₙ₊₁, and Dₙ₊₁ of (1100)ₙ₊₁, respectively. Further, the symbols Aₙ₊₁, Bₙ₊₁, Cₙ₊₁, and Dₙ₊₁ are followed by the symbols Aₙ₊₂, Bₙ₊₂, Cₙ₊₂, and Dₙ₊₂ of (1010)ₙ₊₂, respectively. Further, the symbols Aₙ₊₂, Bₙ₊₂, Cₙ₊₂, and Dₙ₊₂ of (1010)ₙ₊₂ are followed by the symbols Aₙ₊₃, Bₙ₊₃, Cₙ₊₃, and Dₙ₊₃, respectively. When Step 320 is performed again, the expected symbol position generator 130 allows the symbols on the data sequences to shift one symbol position on the channels A, B, C, and D, which can be viewed as adding 1 to the index n. For example, in the second processing stage corresponding to the candidate expected symbol position 420-1, the symbols Aₙ₊₁, Bₙ₊₁, Cₙ₊₁, and Dₙ₊₁ of (1100)ₙ₊₁ (i.e. the logic values 1, 1, 0, and 0) are shifted to the corresponding bold face frames. In the third processing stage corresponding to the candidate expected symbol position 420-2, the symbols Aₙ₊₂, Bₙ₊₂, Cₙ₊₂, and Dₙ₊₂ of (1010)ₙ₊₂ (i.e. the logic values 1, 0, 1, and 0) are shifted to the corresponding bold face frames, and so on.

According to this embodiment, amongst the symbols Aₙ, Bₙ, Cₙ, and Dₙ of (1011)ₙ (i.e. the logic values 1, 0, 1, and 1), the symbol Aₙ may be an example of the first symbol mentioned in Step 230, and the other symbols Bₙ, Cₙ, and Dₙ may be examples of the corresponding first expected symbols mentioned in Step 230; amongst the symbols Aₙ₊₁, Bₙ₊₁, Cₙ₊₁, and Dₙ₊₁ of (1100)ₙ₊₁ (i.e. the logic values 1, 1, 0, and 0), the symbol Aₙ₊₁ may be an example of the second symbol, and the other symbols Bₙ₊₁, Cₙ₊₁, and Dₙ₊₁ may be examples of the corresponding second expected symbols; amongst the symbols Aₙ₊₂, Bₙ₊₂, Cₙ₊₂, and Dₙ₊₂ of (1010)ₙ₊₂ (i.e. the logic values 1, 0, 1, and 0), the symbol Aₙ₊₂ may be an example of the third symbol, and the other symbols Bₙ₊₂, Cₙ₊₂, and Dₙ₊₂ may be examples of the corresponding third expected symbols; amongst the symbols Aₙ₊₃, Bₙ₊₃, Cₙ₊₃, and Dₙ₊₃ of (1101)ₙ₊₃ (i.e., the logic values 1, 1, 0, and 1), the symbol Aₙ₊₃ may be an example of the fourth symbol, and the other symbols Bₙ₊₃, Cₙ₊₃, and Dₙ₊₃ may be examples of the corresponding fourth expected symbols; and so on. Features in this embodiment which are similar to those in the previous embodiments have been omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing de-skew control, the method applied to an electronic device, and comprising:
buffering a plurality of data sequences from a plurality of twisted pairs of a network cable, to perform symbol detection upon a plurality of channels corresponding to the twisted pairs, respectively;
based on a predetermined format, referring to a first symbol on a first channel within the plurality of channels to determine corresponding first expected symbols on other channels of the plurality of channels, in order to determine a plurality of candidate expected symbol positions on the other channels, respectively, wherein the number of the candidate expected symbol positions is larger than the number of the other channels;
based on the predetermined format, referring to at least one other symbol on the first channel to exclude any of the candidate expected symbol positions that does not conform to the predetermined format, in order to obtain a plurality of expected symbol positions on the other channels, respectively, wherein the number of the expected symbol positions is equal to the number of the other channels, and the expected symbol positions correspond to the other channels, respectively; and
utilizing the expected symbol positions as correct positions of the corresponding first expected symbols on the other channels, respectively, and referring to the correct positions to selectively delay at least one data sequence of the data sequences, in order to control respective data of the data sequences to be synchronously transmitted, to thereby perform de-skew.

2. The method of claim 1, wherein the step of buffering the plurality of data sequences from the plurality of twisted pairs of the network cable to perform symbol detection upon the plurality of channels corresponding to the twisted pairs respectively further comprises:
utilizing a first-in-first-out (FIFO) buffer of the electronic device to buffer the data sequences, in order to perform symbol detection upon the channels corresponding to the twisted pairs, respectively.

3. The method of claim 1, wherein the data sequences carry predetermined data conforming to the predetermined format.

4. The method of claim 3, wherein the predetermined data comprises idle data, and the predetermined format comprises an idle data format, wherein the idle data format indicates a predetermined sequential order of a plurality of symbols of the idle data.

5. The method of claim 1, wherein the step of referring to the at least one other symbol on the first channel to exclude any of the candidate expected symbol positions that does not conform to the predetermined format in order to obtain the plurality of expected symbol positions on the other channels respectively further comprises:
based on the predetermined format, referring to the at least one other symbol on the first channel to determine corresponding expected symbols on the other channels, and discarding any of the plurality of candidate expected symbol positions where the corresponding other expected symbols do not respectively appear on the other channels, in order to exclude any of the candidate expected symbol positions that does not conform to the predetermined format.

6. The method of claim 5, wherein the at least one other symbol comprises a plurality of other symbols; and the step of referring to the at least one other symbol on the first channel to exclude any of the candidate expected symbol positions that does not conform to the predetermined format in order to obtain the plurality of expected symbol positions on the other channels, respectively, further comprises:
based on the predetermined format, sequentially referring to the other symbols to discard any of the plurality of candidate expected symbol positions where the corresponding other expected symbols do not respectively appear on the other channels, until each of the other channels only has a unique candidate expected symbol position, wherein the unique candidate expected symbol position is one of the plurality of expected symbol positions.

7. The method of claim 5, wherein the at least one other symbol on the first channel comprises a second symbol; and the step of referring to the at least one other symbol on the first channel to exclude any of the candidate expected symbol positions that does not conform to the predetermined format in order to obtain the plurality of expected symbol positions on the other channels, respectively, further comprises:
based on the predetermined format, referring to the second symbol on the first channel to determine corresponding second expected symbols on the other channels, wherein the corresponding other expected symbols comprise the corresponding second expected symbols; and
discarding any of the candidate expected symbol positions where the corresponding second expected symbols do not respectively appear on the other channels, in order to exclude any of the candidate expected symbol positions that does not conform to the predetermined format.

8. The method of claim 7, wherein the at least one other symbol on the first channel further comprises a third symbol; and the step of referring to the at least one other symbol on the first channel to exclude any of the candidate expected symbol positions that does not conform to the predetermined format in order to obtain the plurality of expected symbol positions on the other channels, respectively, further comprises:
based on the predetermined format, referring to the third symbol on the first channel, to determine the corresponding third expected symbol on the other channels, wherein the corresponding other expected symbols further comprise the corresponding third expected symbols; and
discarding any of the candidate expected symbol positions where the corresponding third expected symbols do not respectively appear on the other channels, in order to exclude any of the candidate expected symbol positions that does not conform to the predetermined format.

9. The method of claim 8, wherein the at least one other symbol on the first channel further comprises a fourth symbol; and the step of referring to the at least one other symbol on the first channel to exclude any of the candidate expected symbol positions that does not conform to the predetermined format in order to obtain the plurality of expected symbol positions on the other channels, respectively, further comprises:
based on the predetermined format, referring to the fourth symbol on the first channel, to determine corresponding fourth expected symbols on the other channels, wherein the corresponding other expected symbols further comprise the corresponding fourth expected symbols; and
discarding any of the candidate expected symbol positions where the corresponding fourth expected symbols do not respectively appear on the other channels, in order to exclude any of the candidate expected symbol positions that does not conform to the predetermined format.

10. The method of claim 1, further comprising:
receiving a plurality of differential signals from the plurality of twisted pairs in the network cable, to obtain the plurality of data sequences, wherein the plurality of data sequences correspond to the plurality of differential signals, respectively.

11. An apparatus for performing de-skew control, comprising:
a buffer, located in an electronic device, the buffer arranged to buffer a plurality of data sequences from a plurality of twisted pairs in a network cable, in order to perform symbol detection upon a plurality of channels corresponding to the plurality of twisted pairs;
a format information generator, located in the electronic device, the format information generator arranged to generate format information of a predetermined format;
an expected symbol position generator, located in the electronic device, the expected symbol position generator coupled to the buffer and the format information generator, wherein based on the predetermined format, the expected symbol position generator refers to a first symbol on a first channel within the plurality of channels to determine corresponding first expected symbols on other channels of the plurality of channels, in order to obtain a plurality of candidate expected symbol positions on the other channels, respectively, wherein the number of the candidate expected symbol positions is larger than the number of the other channels; and based on the predetermined format, the expected symbol position generator refers to at least one other symbol on the first channel to exclude any of the candidate expected symbol positions that does not conform to the predetermined format, to obtain a plurality of expected symbol positions on the other channels, respectively, wherein the number of the plurality of expected symbol positions equals the number of the other channels, and the plurality of expected symbol positions correspond to the other channels, respectively; and
a de-skew circuit, located in the electronic device, the de-skew circuit coupled to the buffer and the expected symbol position generator, and arranged to utilize the plurality of expected symbol positions as correct positions of the corresponding first expected symbols on the other channels, respectively, and refer to the correct positions to selectively delay at least one data sequence of the plurality of data sequences to control respective data of the data sequences to be synchronously transmitted, in order to perform de-skew.

12. The apparatus of claim 11, wherein the buffer comprises a first-in-first-out buffer.

13. The apparatus of claim 11, wherein the plurality of data sequences carry predetermined data conforming to the predetermined format.

14. The apparatus of claim 13, wherein the predetermined data comprises idle data, and the predetermined format comprises an idle data format, wherein the idle data format indicates a predetermined sequential order of a plurality of symbols of the idle data.

15. The apparatus of claim 11, wherein based on the predetermined format, the expected symbol position generator refers to the at least one other symbol on the first channel to determine corresponding other expected symbol on the other channels; and the expected symbol position generator discards any of the plurality of candidate expected symbol positions where the corresponding other expected symbols do not respectively appear on the other channels, in order to exclude any of the candidate expected symbol positions that does not conform to the predetermined format.

16. The apparatus of claim 15, wherein the at least one other symbol comprises multiple other symbols; and based on the predetermined format, the expected symbol position generator sequentially refers to the other symbols to discard any of the candidate expected symbol positions where the corresponding other expected symbols do not respectively appear on the other channels, until each of the other channels only has a unique candidate expected symbol position, wherein the unique candidate expected symbol position is one of the plurality of expected symbol positions.

17. The apparatus of claim 15, wherein the at least one other symbol on the first channel comprises a second symbol; based on the predetermined format, the expected symbol position generator refers to the second symbol on the first channel to determine corresponding second expected symbols on the other channels, wherein the corresponding other expected symbols comprise the corresponding second expected symbols; and the expected symbol position generator discards any of the candidate expected symbol positions where the corresponding second expected symbols do not respectively appear on the other channels, in order to exclude any of the candidate expected symbol positions that does not conform to the predetermined format.

18. The apparatus of claim 17, wherein the at least one other symbol on the first channel further comprises a third symbol; based on the predetermined format, the expected symbol position generator refers to the third symbol on the first channel to determine corresponding third expected symbols on the other channels, wherein the corresponding other expected symbols further comprise the corresponding third expected symbols; and the expected symbol position generator discards any of the candidate expected symbol positions where the corresponding third expected symbols do not respectively appear on the other channels, in order to exclude any of the candidate expected symbol positions that does not conform to the predetermined format.

19. The apparatus of claim 18, wherein the at least one other symbol on the first channel further comprises a fourth symbol; based on the predetermined format, the expected symbol position generator refers to the fourth symbol on the first channel to determine corresponding fourth expected symbols on the other channels, wherein the corresponding other expected symbols further comprise the corresponding fourth expected symbols; and the expected symbol position generator discards any of the candidate expected symbol positions where the corresponding fourth expected symbols do not respectively appear on the other channels, in order to exclude any of the candidate expected symbol positions that does not conform to the predetermined format.

20. The apparatus of claim 11, further comprising:
a receiver stage, located in the electronic device, the receiver stage arranged to receive a plurality of differential signals from the plurality of twisted pairs in the network cable, respectively, to obtain the plurality of data sequences, wherein the plurality of data sequences correspond to the plurality of differential signals, respectively.
